(19) United States
(12) Patent Application Publication
(10) Pub. No.: US 2015/0374157 A1
(43) Pub. Date: Dec. 31, 2015

(54) Anti-Skid/Anti-Slip Safety Mat

(71) Applicant: Jason Bone, North Richland Hills, TX (US)

(72) Inventor: Jason Bone, North Richland Hills, TX (US)

(21) Appl. No.: 14/317,129

(22) Filed: Jun. 27, 2014

(51) Int. Cl. A47G 27/02; C09D 163/00

(52) U.S. Cl. CPC A47G 27/02; C09D 163/00

(57) ABSTRACT

The anti-skid/anti-slip safety mat is composed of a fiberglass mesh base layer onto which is layered a fiberglass or epoxy resin. Crushed aggregate is broadcast onto the fiberglass or epoxy resin which will bind to the fiberglass mesh base layer as the fiberglass or epoxy resin cures. The result is a nonskid/nonslip safety mat that can be used as a safety device in a variety of commercial, industrial and residential applications. The anti-skid/anti-slip safety mat can be constructed in various sizes and shapes to accommodate the surface to be covered.

### CROSS-REFERENCE TO RELATED APPLICATIONS

This utility patent application seeks priority to and benefit of U.S. Provisional Patent Application No. 61/957,303 filed on Jun. 28, 2013.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None

### REFERENCE TO A SEQUENCE LISTING

Not applicable.

### BACKGROUND OF THE INVENTION

1. Field

The field of the invention disclosed herein is a safety device which prevents slips and falls in a variety of industrial, commercial and residential environments.

2. Description of the Prior Art

Mats and other devices have long been used on walking surfaces to prevent injury from a slip and fall. Surfaces exposed to the weather are especially prone to becoming slippery when wet. Indoor surfaces can also pose a hazard when they become wet or soiled with grease and grime. In addition passageways such as ramps, inclines and other elevated surfaces can be difficult to traverse without a means of traction on the surface.

Various products and methods have been developed to provide surface traction and prevent injury from a slip and fall. For example, in concrete surfaces, grooves have been placed in the concrete in a perpendicular orientation to the direction of travel. Strips of material embossed with a gritty material have been placed on ramps and steps to provide traction. Safety mats has also been used on steps, ramps, ladders and other walkways to promote safe passage. These mats may be constructed of a natural or artificial fiber or may be constructed from a base surface coated with an abrasive substance such as crushed stone to provide suitable safe traction.

These attempts suffer from a variety of drawbacks. In the case of grooves placed into concrete, the grooves must be created while the concrete is still curing. This can be an expensive exercise and the grooves formed in the concrete are permanent and cannot be relocated. Safety mats suffer from a lack of durability and flexibility. With time, use and exposure to the elements the mats deteriorate and can become a hazard in and of itself. In addition many of these types of safety mats are permanently affixed to the surface making it difficult to remove and replace when needed. These products may delaminate, tear, and lose adhesive properties which may shorten their functional life. These prior art safety mats also lose their functionality when covered with mud, ice, snow or water. What is needed in the art is an anti skid, anti slip safety mat which is durable, flexible and provides superior traction when covered with mud, ice, snow, water and other materials

### BRIEF DESCRIPTION OF THE PRESENT INVENTION

The invention disclosed herein is an anti skid/anti slip safety mat which is durable, flexible and provides superior traction when covered with mud, ice, snow, water and other materials. Specifically, the invention disclosed herein is an anti skid/anti slip safety mat. The anti slip/antiskid safety mat disclosed herein provides a deeper textured abrasive profile to withstand the accumulation of mud, ice, snow and other materials and still provide sufficient traction for safety. The anti skid/anti slip safety mat disclosed herein consists of a layer of flat mesh, cloth or woven mat of fiberglass. The fiberglass layer is covered with a fiberglass or epoxy resin binder which is moisture tolerant and composed of 100% solids. While the fiberglass or epoxy resin is curing, a ⅛″ to ½″ layer of crushed aggregate is broadcast onto the moist fiberglass or epoxy resin binder. The crushed aggregate may be selected from flint rock, granite, limestone, shell, slag abrasive or sand. The depth of the aggregate may be adjusted according to the application. Additionally, the crushed aggregate may be of different grits (sizes) in order to construct a more or less gritty surface of the anti skid/anti slip safety mat as desired. Optionally, a metal lath can be attached to the underside of the anti skid/anti slip safety mat around the border of the anti skid/anti slip safety mat to provide more support to the safety mat. Typically, the metal lath is approximately 1″ wide but may be of different widths depending on the amount of support needed. The anti skid/anti slip safety mat can be attached to most any surface by threaded fasteners such as readily available screws or other fasteners. Attachment of the anti skid/anti slip safety mat to a surface by threaded fasteners enables the quick removal of the anti skid/anti slip safety mat in the event of a need for maintenance or to reconfigure the positioning of the anti slip/anti skid safety mat. The anti skid/anti slip safety mat may be constructed in various sizes and shapes. Moreover, the anti skid/anti slip safety mat can be cut according to the size required for the application. The anti skid/anti slip safety mat is flexible, durable, lightweight, waterproof and provides traction when covered with snow, ice, water and/or mud.

In another embodiment of the invention disclosed herein, the anti skid/anti slip safety mat can be used as a durable roofing tile, wall siding, countertop and floor tile. The anti skid/anti slip safety mat may be used in a variety of commercial, industrial and residential applications. Those include walkways in factories, offshore oil platforms, refineries, chemical plants, loading docks and many other environments.

### BRIEF DESCRIPTION OF THE DRAWING/FIGURES

A better understanding of the invention disclosed herein may be had by examination of the following drawing/figures:

FIG. 1 is a cross section of the anti-skid/anti-slip safety mat.

### DETAILED DESCRIPTION OF THE INVENTION

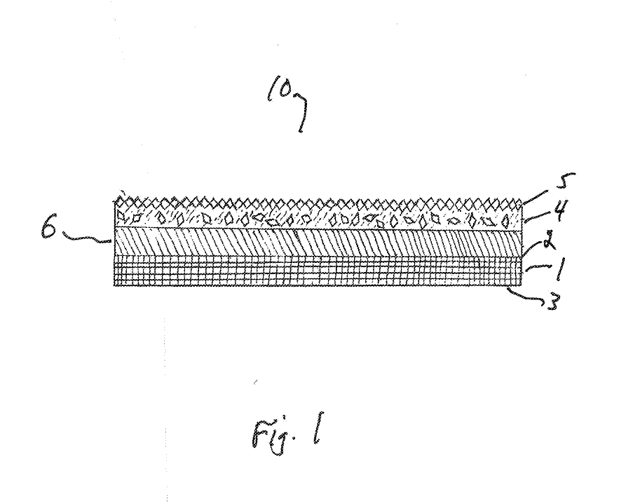

As shown in FIG. 1, the anti-skid/anti-slip mat 10 is composed of a mesh base layer 1 of flat mesh, cloth or woven mat of fiberglass. In another embodiment materials other than fiberglass may also be used to construct the mesh base layer 1. The top side 2 of the mesh base layer 1 is coated with a binder 4 which is used to bind or attach the crushed aggregate 5 to the mesh base layer 1. The binder 4 may be a fiberglass resin or in another embodiment, epoxy resin. Upon curing of the binder 4, the crushed aggregate 5 is firmly attached to the mesh base layer 1. The crushed aggregate 5 may be selected from flint rock, granite, limestone, shell, slag abrasive or sand. The depth of the crushed aggregate 5 may be adjusted according to the application. Additionally, the crushed aggregate 5 may be of different grits (sizes) in order to construct a more or less gritty surface of the anti skid/anti slip safety mat 10 as desired.

Optionally, and as shown in FIG. 1, a metal lath 6 can be attached to the outside perimeter of the mesh base layer 1 anti skid/anti slip safety mat 10 to provide more support to the anti-skid/anti-slip safety mat 10. Typically, the metal lath 6 is approximately 1″ wide but may be of different widths depending on the amount of support needed. The anti skid/anti slip safety mat 10 can be attached to most any surface by threaded fasteners such as readily available screws or other fasteners. Attachment of the anti skid/anti slip safety mat 10 to a surface by threaded fasteners enables the quick removal of the anti skid/anti slip safety mat in the event of a need for maintenance or to reconfigure the positioning of the anti slip/anti skid safety mat 10.

The anti-skid/anti-slip safety mat can be configured into many sizes and shapes to fit the particular application. Moreover, the size and depth of the crushed aggregate broadcast onto the binder coated surface can be varied to construct an anti-skid/anti-slip safety mat with more or less anti-slip/anti-skid properties as desired. All of these other embodiments are specifically incorporated into the specification as if fully described.

I claim:

1. An anti-skid/anti-slip safety mat comprising:
a mesh base layer with a bottom side and top side;
a binder spread on said top side of said mesh base layer;
a crushed aggregate layered on top of said binder;
a metal lathe affixed to said bottom side of said mesh base layer and extending around the perimeter of said mesh base layer.

2. The anti-skid/anti slip safety mat defined in claim 1 wherein said mesh base layer is constructed from fiberglass.

3. The anti-skid/anti slip safety mat defined in claim 1 wherein said binder is a fiberglass resin.

4. The anti-skid/anti-slip safety mat defined in claim 1 wherein said binder is an epoxy resin.

5. The anti-skid/anti-slip safety mat defined in claim 1 wherein said crushed aggregate is granite.

6. The anti-skid/anti-slip safety mat defined in claim 1 wherein said crushed aggregate is flint rock.

7. The anti-skid/anti-slip safety mat defined in claim 1 wherein said crushed aggregate is limestone.

8. The anti-skid/anti-slip safety mat defined in claim 1 wherein said crushed aggregate is sand.

9. The anti-skid/anti-slip safety mat defined in claim 1 wherein said crushed aggregate is shell.

10. The anti-skid/anti-slip safety mat defined in claim 1 wherein said crushed aggregate is slag abrasive.
